(19) United States
(12) Patent Application Publication
(10) Pub. No.: US 2008/0060255 A1
(43) Pub. Date: Mar. 13, 2008

(54) Tackle Box System

(76) Inventors: Noel C. Duncan, Plantation, FL (US); Wallace J. Paradis, Plantation, FL (US)

Correspondence Address: LAW OFFICE OF STEVEN B. LEAVITT, L.L.P., 130 Meadowcreek, Rockwall, TX, 75032, US

(21) Appl. No.: 11/531,276

(22) Filed: Sep. 12, 2006

(51) Int. Cl. A01K 97/06

(52) U.S. Cl. 43/54.1; 206/315.11

(57) ABSTRACT

The present invention is directed to a tackle box system that cleans, stores and dries fishing tackle. The tackle box system includes at least one storage tray and a base unit. The storage tray has a top wall and a bottom wall, wherein each wall comprises a plurality of perforations. The base unit comprises an interior space wherein at least a portion of the storage tray fits within the interior space. The base unit further includes at least one fan for blowing air into the storage tray.

### BACKGROUND OF THE INVENTION

1. Technical Field

This invention relates to tackle boxes, and more particularly, to a tackle box system for cleaning, drying and storing fishing tackle.

2. Description of Related Art

Fishing is a very ancient practice that dates back at least to the Mesolithic period, which began about 10,000 years ago. During that time, fishing was done out of necessity for food and involved either a simple net or a hook on a line. The bait used, if any, was relatively simple and mostly comprised of the fish's natural prey. Since then, a portion of fishing has evolved into a recreational activity done for pleasure or competition and the equipment used has become very sophisticated and relatively expensive. This is especially true for lures and in particular saltwater fishing lures.

One of the drawbacks of saltwater fishing is that corrosion of the lure is a common problem. During the normal course of fishing, the lure is exposed to salt water, dirt and other debris. If the lure is not properly cleaned immediately after use, degradation of the lure will occur as the saltwater has a highly corrosive effect on the lure. In addition, typically, after both freshwater and saltwater fishing, often the lure is not dried immediately after use, which results in rusting of the lure.

Each of the above factors causes irreparable damage to the fishing lure, and wreaks havoc with the working parts of the lure, especially the hooks. Such damage often requires premature replacement of the lure that can be relatively expensive.

To help prevent such damage and reduce expenses, a device is needed that ensures proper care and maintenance of the lure. It would be beneficial if such a device could also be used to store the lure.

### SUMMARY OF INVENTION

The present invention solves the above-described problems by providing a tackle box system that effectively cleans, dries, and stores fishing tackle after use. The tackle box system of the present invention includes at least one storage tray and a base unit. The storage tray has a top wall and a bottom wall, wherein each wall comprises a plurality of perforations. The base unit comprises an interior space wherein at least a portion of the storage tray fits within the interior space. The base unit further includes at least one fan for blowing air into the storage tray.

More particularly, the base unit includes a front wall, a back wall, a top wall and at least two sidewalls. Preferably a door is movably attached to the front wall for allowing access to the interior space of the base unit. Each sidewall has an interior surface and an exterior surface. At least one elongated ridge may be located on the interior surface of each sidewall. When the storage tray is placed within the base unit, a portion of the storage tray rests on the elongate ridge located on each sidewall.

Another aspect of the present invention is directed to a method of cleaning, storing and drying at least one fishing lure and/or tackle. The method includes rinsing the lure and/or tackle, and then placing the lure and/or tackle in a storage tray having a top wall and a bottom wall. The top wall and bottom wall each comprise a plurality of perforations. At least a portion of the storage tray is placed within the interior space of a base unit, and the lure and/or tackle are dried by blowing air into the storage tray via a fan attached to the base unit.

More particularly, the lure and/or tackle and the storage tray are rinsed with fresh water, and the lure and/or tackle are dried for approximately 10 minutes to approximately 2 hours.

Yet, another aspect of the present invention is directed to an alternative method of cleaning, storing and drying at least one lure and/or tackle. This method includes placing at least one lure and/or tackle in a storage tray having a top wall and a bottom wall, wherein each wall comprises a plurality of perforations. The storage tray and lure and/or tackle are rinsed. Then, at least a portion of the storage tray is placed within the interior space of a base unit, and the lure and/or tackle are dried by blowing air into the storage tray via a fan attached to the base unit.

Other features and advantages of the present invention will become apparent upon reading the following detailed description of embodiments of the invention, when taken in conjunction with the appended claims.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a front view of a tackle box system made in accordance with an embodiment of the present invention;

FIG. 2 is a perspective view of a storage tray used in the tackle box system of the present invention;

FIG. 3 is a perspective view of an open base unit used in the tackle box system of the present invention;

FIG. 4 is a top view of a tackle box system made in accordance with an embodiment of the present invention;

FIG. 5 is a front view of a closed base unit used in the tackle box system of the present invention; and

FIG. 6 is a flow diagram depicting the steps used in accordance with an embodiment of the present invention.

### DETAILED DESCRIPTION OF THE INVENTION

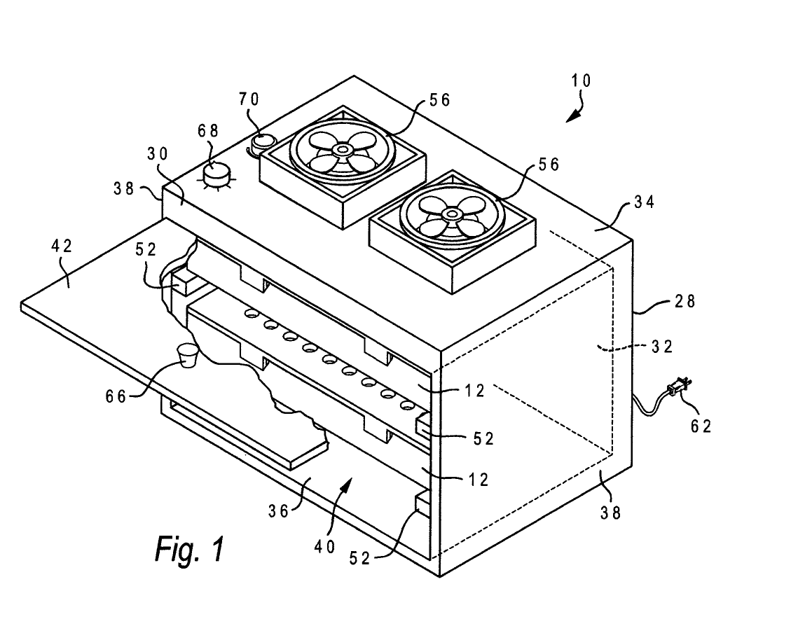

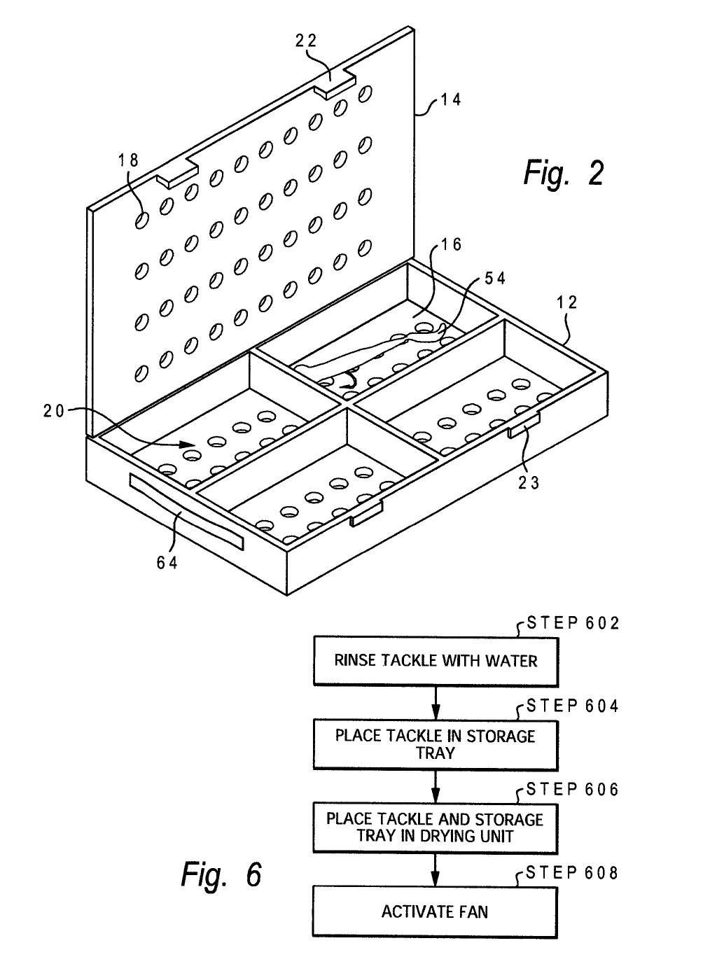

Referring to FIGS. 1-3, shown is tackle box system 10 for cleaning, storing and drying at least one fishing lure and/or tackle. Hereinafter, the term tackle will be used to refer both to at least one fishing lure and tackle. The tackle box system 10 includes at least one storage tray 12 having a top wall 14 and a bottom wall 16, as shown in FIG. 2. Storage tray 12 can accommodate at least one tackle 54. Tackle 54 may be any lure or tackle known in the art.

Top wall 12 and bottom wall 14 of storage tray 12 each have a plurality of perforations 18. Storage tray 12 preferably includes multiple compartments 20 which may be of varying sizes, for holding tackle 54. Perforations 18 may be any size and shape which allows water to pass through the perforations, and also allows air to pass through the perforations and storage tray 12 to dry tackle 54 located within the tray. In addition, perforations 18 must be a size and shape that prevents tackle 54 from falling out of the storage tray 12.

Storage tray 12 may be comprised of any material that is water resistant, and durable enough to hold and transport tackle 54. Suitable materials the storage tray 12 may be comprised of include, but are not limited to plastic, wood, fiberglass or any other similar rigid material. Preferably, storage tray 12 is comprised of plastic. Storage tray 12 also includes closure 22 for opening and closing storage tray 12. Any closure 22 known to those having skill in the art may be used in the present invention, including, but not limited to a latch, snap, adhesive or a mechanical attachment means such as a snap, button, zipper, hook-and-loop, Velcro®, magnet, or any other similar mechanical fastener that requires the mating of two parts. Furthermore, handle 64 may be present on storage tray 12 for easily transporting storage tray 12 during use.

Storage tray 12 preferably has a length between approximately 12 inches and approximately 36 inches, a width between approximately 15 inches and approximately 30 inches, and a height between approximately 0.75 inches and approximately 12 inches.

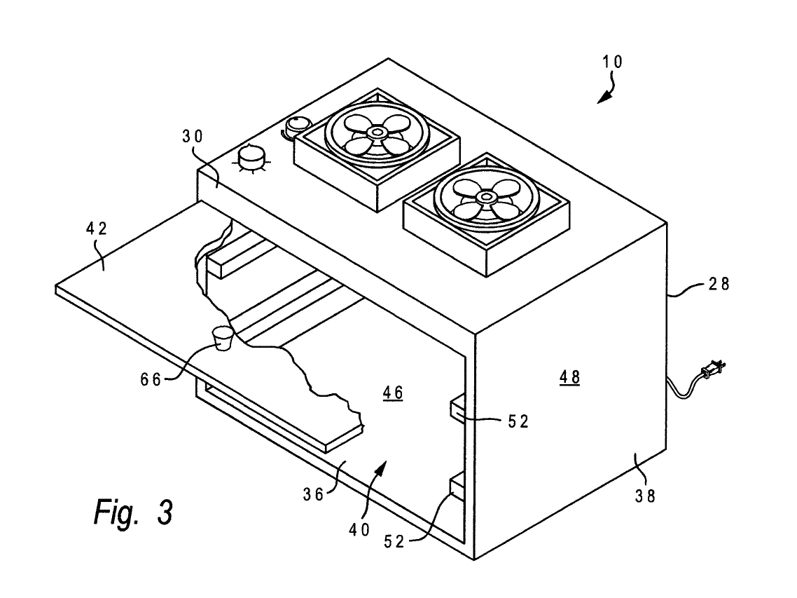

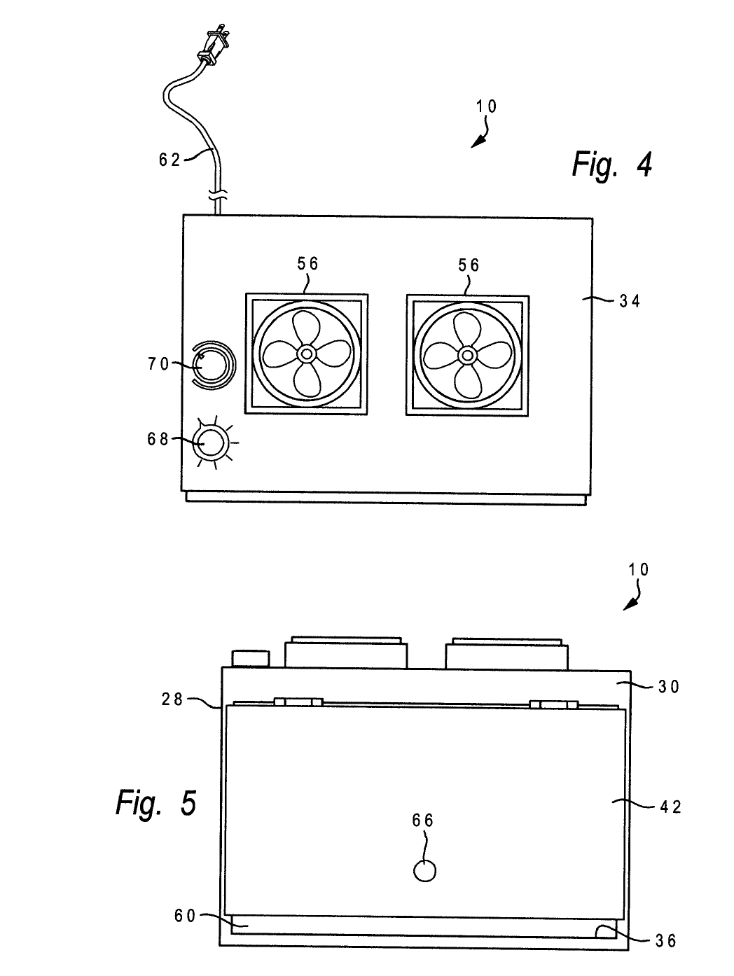

Tackle box system 10 of the present invention also includes base unit 28 having front wall 30, FIG. 3, back wall 32, top wall 34, FIG. 4, bottom wall 36, and at least two sidewalls 38. Front wall 30, back wall 32, top wall 34, bottom wall 36, and at least two sidewalls 38 define interior space 40, wherein at least a portion of storage tray 12 fits within interior space 40. Base unit 28 preferably includes door 42. Door 42 is movably attached to front wall 30 for opening and closing base unit 28. Preferably, door 42 opens horizontally. In addition, door 42 may include door handle 66 to assist in opening and closing door 42.

Base unit 28 preferably has a length between approximately 13 inches and approximately 37 inches, a width between approximately 16 inches and approximately 32 inches, and a height between approximately 13 inches and approximately 37 inches.

Each sidewall 38 of base unit 28 comprises an interior surface 46 and an exterior surface 48, as shown in FIG. 3. Preferably, at least one elongate ridge 52 is located on the interior surface 46 of each sidewall 38, wherein elongate ridges 52 are parallel to each other (see FIG. 1). When storage tray 12 is placed within base unit 28, a portion of storage tray 12 will rest on elongate ridge 52 located on each sidewall 38. Specifically, as storage tray 12 is placed within interior space 40 of base unit 28, bottom wall 16 of storage tray 12 may be slid along the top of each elongate ridge 52. Once storage tray 12 is inside base unit 28, a portion of bottom wall 16 of storage tray 12 rests on the top of each elongate ridge 52.

Preferably, a first and second elongate ridge 52 is located on interior surface 46 of each sidewall 38 base unit 28, wherein the first elongate ridge 52 on the first sidewall 38 is parallel to the first elongate ridge 52 on the second sidewall 38, and the second elongate ridge 52 on the first sidewall 38 is parallel to the second elongate ridge 52 on the second sidewall 38. Accordingly, two storage trays 12 may be placed within interior space 40 of base unit 28, one storage tray 12 resting on the first set of elongate ridges 52 and a second storage tray 12 resting on the second set of elongate ridges 52. Numerous sets of parallel elongate ridges 52 may be located on the base unit sidewalls 38 to accommodate a plurality of storage trays 12.

Each elongate ridge 52 preferably has a length between approximately 8 inches and approximately 12 inches, a width between approximately 0.5 inches and approximately 2 inches, and a height between approximately 0.50 inches and approximately 2 inches.

Base unit 28, including elongate ridges 52, may be comprised of any material that is water resistant and durable enough to support storage tray 12. Suitable materials base unit 28 may be comprised of include, but are not limited to plastic, wood, fiberglass or any other similar rigid material. Preferably, base unit 28 is comprised of plastic.

Base unit 28 also includes at least one fan 56 for blowing air into storage tray 12, as shown in FIG. 4. Preferably, base unit 28 includes two fans 56, each attached to top wall 34 of base unit 28. In this configuration, fans 56 are positioned to blow air through perforated top wall 14 of storage tray 12 and out perforated bottom wall 16 of storage tray 12. Fan 56 may be attached or mounted to base unit 28 by any means known to those skilled in the art. While fan 56 is shown extending from top wall 34, fan 56 may be flush with top wall 34. In addition, any type fan 56 may be used in tackle box system 10 of the present invention that is capable of effectively drying tackle 54 located in storage tray 12. For example, each fan 56 may have a voltage between approximately 10 volts and approximately 300 volts. Preferably, each fan 56 has a voltage between approximately 12 volts and approximately 220 volts.

As illustrated in FIG. 5, gap 60 may be present between door 42 and bottom wall 36 of base unit 28, when door 42 is in a closed position. Gap 60 provides an exit for the air flow in base unit 28 created by fan 56. Preferably, gap 60 is between approximately 1.0 inch and 3.0 inches high.

Base unit 28 may include timer 68 for setting fan 56 to operate for a predetermined period of time. In addition, base unit 28 may include fan speed adjuster 70 for regulating the operating speed of fan 56. Timer 68 and fan speed adjuster 70 may each include detailed information regarding the appropriate time setting and speed setting for particular types of tackle to be dried. Any timer or fan speed adjuster known to those having skill in the art may be used in tackle box system 10 of the present invention.

Base unit 28 may include batteries (not shown) to operate fan 56, and/or base unit 28 may include electrical plug 62 to operate fan 56, as shown in FIG. 4.

The present invention is also related to a method of cleaning, storing and drying tackle. The storage tray 12 may be used alone to carry tackle 54 to the fishing site, or the entire base unit 28 with the storage tray(s) 12 inside may be transported to the fishing site, because tackle box system 10 of the present invention is portable. In an alternative embodiment, base unit 28 may be conveniently placed or mounted on a boat.

As shown in FIG. 6, after the tackle 54 has been used, tackle 54 is rinsed with fresh water or any other suitable liquid to remove salt water, dirt or any other unwanted residue from tackle 54, Step 602. Tackle 54 is then placed into storage tray 12, Step 604. Alternatively, tackle 54 may be rinsed after being placed in storage tray 12. While tackle 54 is located in storage tray 12, tackle 54 and at least a portion of storage tray 12 are rinsed to remove salt, dirt, residue, etc. In this alternative method, the rinsing process may be performed by running fresh water or any other suitable liquid over storage tray 12, wherein the liquid enters and exits the storage tray through the perforations 18 to clean tackle 54. Tackle 54 may also be cleaned by dipping tackle 54 and at least a portion of storage tray 12 into fresh water or any other suitable liquid, wherein the liquid enters and exits storage tray 12 through perforations 18 and cleans tackle 54.

Next, each storage tray 12 is placed within interior space 40 of base unit 28, and base unit door 42 is closed, Step 606. Fan 56 located in base unit 28 are then activated to dry tackle 54 located in storage tray 12, Step 608. Fan 56 may be set to operate for a predetermined period of time and/or at a predetermined speed depending upon the type of tackle to be dried. On average, the tackle is dried in base unit 28 for approximately 10 minutes to approximately 2 hours.

As used in the present invention, the term fishing tackle means any equipment used for fishing, including, but not limited to weights, hooks, fishing line, lures, etc. It should be understood that tackle box system 10 and method of the present invention can be used to clean, store and dry other items and equipment besides fishing tackle.

It should also be understood that the foregoing relates to exemplary embodiments of the invention and that modifications may be made without departing from the spirit and scope of the invention as set forth in the following claims.

What is claimed is:

1. A tackle box system comprising:
at least one storage tray having a top wall and a bottom wall, the top wall and bottom wall each comprising a plurality of perforations; and
a base unit having an interior space wherein at least a portion of the storage tray fits within the interior space, and the base unit comprises at least one fan for blowing air into the storage tray.

2. The tackle box system of claim 1, wherein the base unit comprises a front wall, a back wall, a top wall, and at least two sidewalls.

3. The tackle box system of claim 2, wherein the base unit further comprises a door movably attached to the front wall for opening and closing the base unit.

4. The tackle box system of claim 3, wherein the base unit further comprises a bottom wall, and wherein a gap exists between the door and the bottom wall when the door is in a closed position.

5. The tackle box system of claim 2, wherein each sidewall has an interior surface and an exterior surface, and the base unit further comprises at least one elongate ridge located on the interior surface of each sidewall, and wherein a portion of the storage tray rests on the elongate ridge located on each sidewall when the storage tray is placed within the base unit.

6. The tackle box system of claim 5, wherein a first and second elongate ridge is located on the interior surface of each sidewall, wherein the first elongate ridge on the first sidewall is parallel to the first elongate ridge on the second sidewall, and wherein the second elongate ridge on the first sidewall is parallel to the second elongate ridge on the second sidewall.

7. The tackle box system of claim 2, wherein the fan is located proximate the top wall of the base unit.

8. The tackle box system of claim 7, wherein the base unit comprises two fans for blowing air into the storage tray.

9. The tackle box system of claim 1, wherein the storage tray comprises a plurality of compartments for holding tackle.

10. The tackle box system of claim 1, wherein the storage tray has a length between approximately 12 inches and approximately 36 inches, a width between approximately 15 inches and approximately 30 inches, and a height between approximately 0.75 inches and approximately 12 inches.

11. The tackle box system of claim 1, wherein the base unit has a length between approximately 13 inches and approximately 37 inches, a width between approximately 16 inches and approximately 32 inches, and a height between approximately 13 inches and approximately 37 inches.

12. The tackle box system of claim 1, wherein the system is portable.

13. The tackle box system of claim 1, wherein the storage tray is comprised of plastic, wood, or fiberglass.

14. The tackle box system of claim 13, wherein the storage tray is comprised of plastic.

15. The tackle box system of claim 1, wherein the base unit is comprised of plastic, wood, fiberglass.

16. The tackle box system of claim 15, wherein the base unit is comprised of plastic.

17. The tackle box system of claim 1, wherein the base unit further comprises a timer for setting the fan to operate for a predetermined period of time.

18. The tackle box system of claim 1, wherein the base unit further comprises a fan speed adjuster for regulating the operating speed of the fan.

19. A method of cleaning, storing and drying tackle comprising:
rinsing tackle;
placing the tackle in a storage tray having a top wall and a bottom wall, the top wall and bottom wall each comprising a plurality of perforations;
placing at least a portion of the storage tray within an interior space of a base unit; and
drying the tackle by blowing air into the storage tray via a fan attached to the base unit.

20. The method of claim 19, wherein the tackle is rinsed with fresh water.
